(19) United States
(12) Patent Application Publication
(10) Pub. No.: US 2010/0116153 A1
(43) Pub. Date: May 13, 2010

(54) EASY-TO-USE FOOD SLICER

(76) Inventors: Zhiyang Chen, Columbia, SC (US); Shu Liu, Columbia, SC (US)

Correspondence Address: ZHIYANG CHEN, APT B, 1006 MARION ST., COLUMBIA, SC, 29201, US

(21) Appl. No.: 12/267,791

(22) Filed: Nov. 10, 2008

(51) Int. Cl. A47J 43/04; B26B 15/00

(52) U.S. Cl. 99/538; 30/277.4

(57) ABSTRACT

An easy-to-use food slicer can slice food into predetermined thickness. This easy-to-use food slicer includes a motor 30 and a structure 10 in which the belt blade 14, four sets of pulleys 11, 11′, 23, 23′ and a driving transmission system 12, 12′, 13, 13′, 15, 16, 16′, 17, 17′, 18, 19, 19′, 20, 20′ are installed, four sets of pulleys 11, 11′, 23, 23′ and a driving transmission system 12, 12′, 13, 13′, 15, 16, 16′, 17, 17′, 18, 19, 19′, 20, 20′. The driving transmission system transforms rotation movement of motor 30 into back and forth movement of belt blade 14, which cuts food under the easy-to-use food slicer.

This is a nonprovisional utility patent application from Zhiyang Chen and Shu in. Both of them are citizens of People's Republic of China. Both of them live in united state currently. Their current address is: apt B, 10006 Marion ST., Columbia, S.C., 29201. The title of this invention is “An Easy-to-use Food Slicer”

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of the invention

The present invention relates to an easy-to-use food slicer in which a long belt blade is installed. This belt blade is pulled back and forth by an electric motor and transmission system. Food under this slicer is cut to predetermined thickness when this slicer is pressed by users.

2. Description of Related Art

This invention can slice both meat and vegetables into fine pieces. Food processors are expensive and not convenient to use to prepare food slice for a family. Conventional food slicers are either too complex because of using electrical motors in them or difficult to use without electrical motor. To make a food slicer easy to use for a regular family is needed.

This invention refers to united state patent with U.S. Pat. No. 7,055,516.

### BRIEF SUMMARY OF THE INVENTION

To make food slicers easy for family to use, it is an object of the present invention to provide a food slicer to cut food into pieces having a predetermined thickness, which is easier and more efficient than conventional food slicer.

To achieve the object of the present invention, there is provided a food slicer comprising a motor, a driving transmission system, belt blade and a structure where belt blade and driving transmission system and motor are installed. The driving transmission system pulls the belt blade from two terminals alternatively so that the blade moves back and forth repeatedly, which will cut food under the food slicer into predetermined thickness.

The belt blade is fabricated with a very thin and strong metal belt which has smooth verges. Food is sliced when slicer is pressed on it.

### BRIEF DESCRIPTION OF THE SEVERAL VIEWS OF THE DRAWING

FIG. 1 is a perspective view of an easy-to-use food slicer according to the present invention;

FIG. 2 is a side view of the easy-to-use food slicer according to the present invention;

FIG. 3 is a plan view of the easy-to-use food slicer according to the present invention;

FIG. 4 is a plan view FIG. 4A and front view FIG. 4B of the driving transmission system according to the present invention;

FIG. 5 is an enlarged front view of a part of the driving transmission system according to the present invention;

FIG. 6 is a plan view FIG. 6A and front view FIG. 6B of pulleys around which belt blade is installed according to the present invention;

FIG. 7 is an operation state diagram of the easy-to-use food slicer according to the present invention.

### DETAILED DESCRIPTION OF THE INVENTION

Now the reference will be made to the drawings.

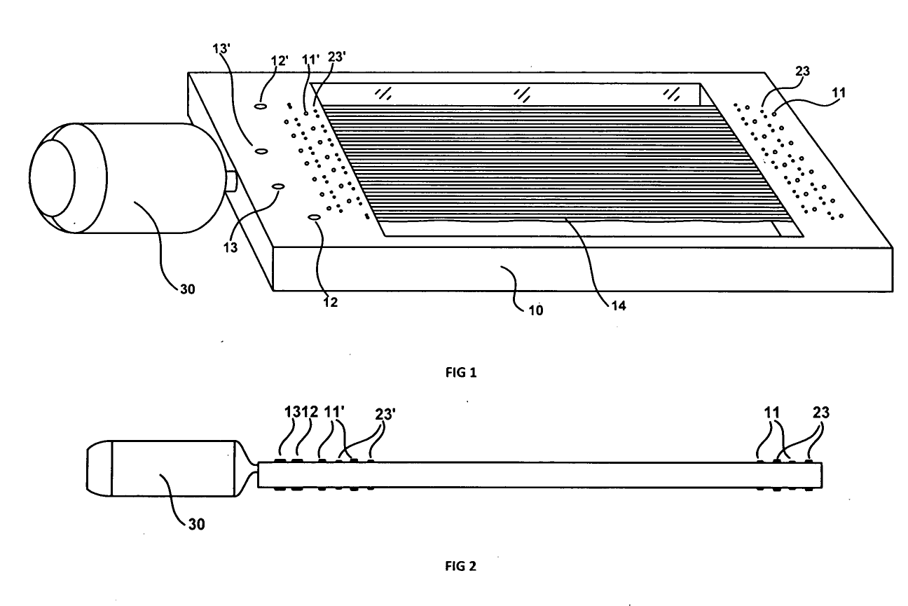

FIG. 1 is a perspective view of an easy-to-use food slicer according to the present invention.

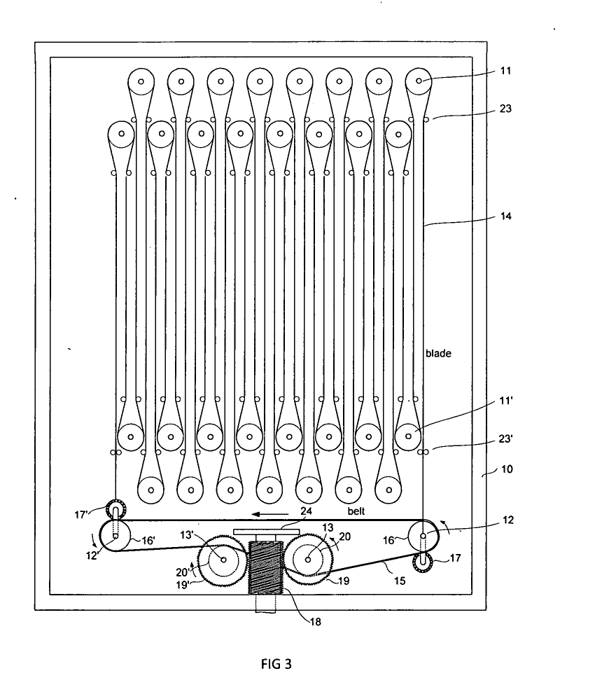

As shown in FIG. 1 and FIG. 2, the easy-to-use food slicer according to the present invention includes a motor 30 and a structure 10 in which the belt blade 14, four sets of pulleys 11, 11′, 23, 23′ and a driving transmission system 12, 12′, 13, 13′, 15, 16, 16′, 17, 17′, 18, 19, 19′, 20, 20′ are installed, four sets of pulleys 11, 11′, 23, 23′ and a driving transmission system 12, 12′, 13, 13′, 15, 16, 16′, 17, 17′, 18, 19, 19′, 20, 20′.

The belt blade is very thin and narrow and fabricated with strong and durable metal so that it can bent around pulleys 11, 11′, 23, 23′ and withstand vertical force applied by users of the easy-to-use food slicer.

The driving transmission system transforms rotation movement of motor 30 into back and forth movement of belt blade 14. As shown in FIG. 3, the driving transmission system includes one helical gear 18 connected to motor 30, two vertical gears 19 and 19′ connected to helical gears 18, two driving pulleys 20 and 20′ which are installed on the same shafts with gears 19 and 19′, a driving belt 15 which drives pulleys 16 and 16′, two driven pulleys 16 and 16′ which are driven by driving belt 15, two crank shafts 12 and 12′ which are driven by pulley 16 and 16′, two rollers 17 and 17′ which are installed on crank shafts 12 and 12′ and are used to connect belt blade with driving transmission system. The rotation of motor 30 makes vertical gears 19 and 19′ rotate. Rotation of vertical gears 19 and 19′ makes two driving pulleys 20 and 20′ rotate, which causes movement of driving belt 15. Driving belt 15 makes two driven pulleys 16 and 16′ rotate, which causes crank shafts 12 and 12′ rotate in the direction. The rotation of crank shaft 12 and 12′ cause rollers 17 and 17′ rotate horizontally, which pull the belt blade 14 from both terminals alternatively.

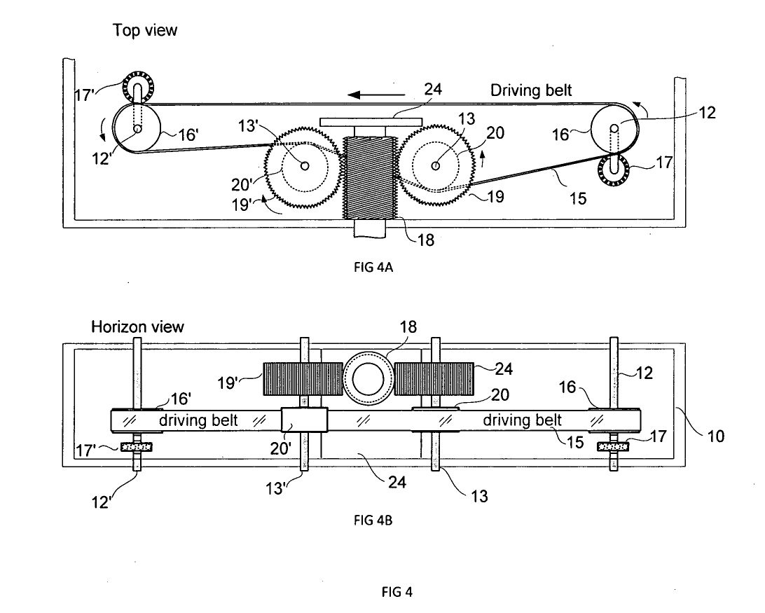

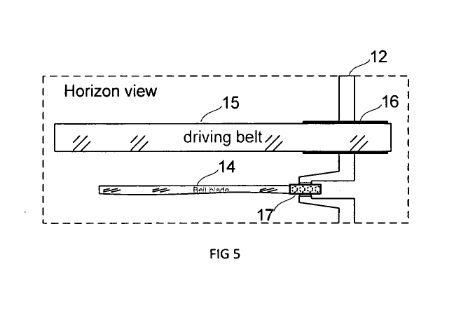

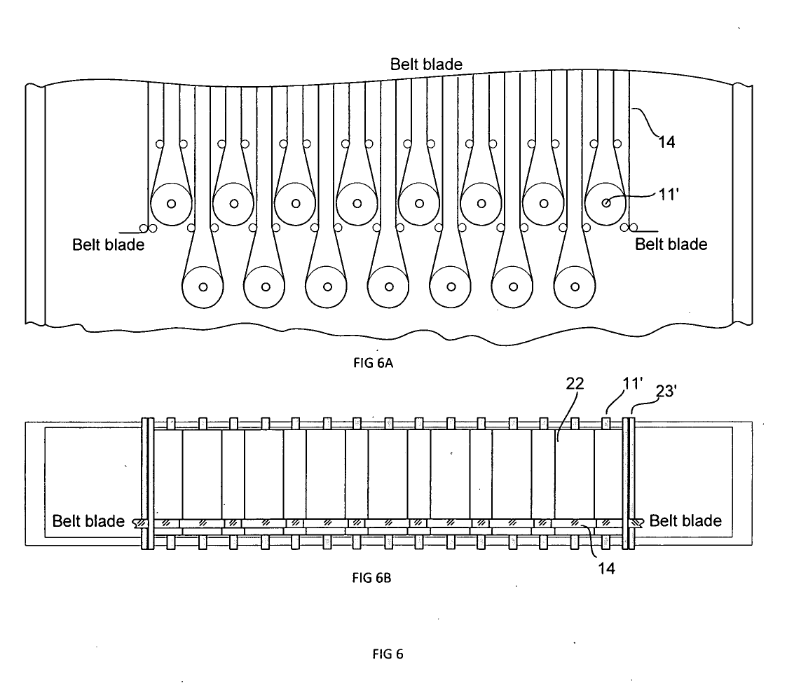

As shown in FIG. 4A and FIG. 4B, vertical gears 19 and 19′ and helical gear 18 are on the top of the structure 10. Pulleys 16, 16′, 20 and 20′ are in the middle level. Rollers 17 and 17′ and belt blade 14 are in the bottom level. The shape of crank shaft 12 and 12′ are shown in FIG. 5. Side view of pulley sets 11 and 11′ and belt blade 14 are shown in FIG. 6A and FIG. 6B.

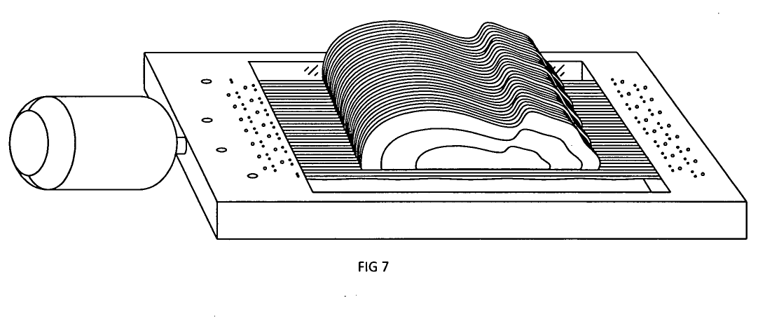

As shown in FIG. 7, in the easy-to-use food slicer according to the present invention, food will be sliced by belt blade 14 when users of food slicer press the slicer through food.

What I claim as my invention is:

1. An easy-to-use food slicer, comprising:
a structure where four sets of pulleys, driving transmission system and a motor are installed;
a belt blade;
four sets of pulleys around which the belt blade is installed;
a motor which generates rotation movement;
a transmission system which transforms rotation movement of motor into straight back and forth movement of belt blade, comprising:
a helical gear which is connected to a motor;
two vertical gears which are connected to the helical gear;
two driving pulleys which are installed on the same shaft with each vertical gear;
a driving belt with is installed on two driving pulleys and two driven pulleys;
two driven pulleys which are driven by driving pulley;
two crank shafts on which each driven pulley is installed;
two rollers which is installed on each crank shaft.
